(19) United States
(12) Patent Application Publication
(10) Pub. No.: US 2019/0287325 A1
(43) Pub. Date: Sep. 19, 2019

(54) SYSTEM AND METHOD FOR DETECTING AND ANONYMOUSLY TRACKING FIREARMS INCLUDING A DECENTRALIZED DISTRIBUTED LEDGER SYSTEM

(71) Applicant: Skypath Security, Inc., Providence, RI (US)

(72) Inventor: David R. Paolo, Providence, RI (US)

(73) Assignee: Skypath Security, Inc., Providence, RI (US)

(21) Appl. No.: 16/357,389

(22) Filed: Mar. 19, 2019

Related U.S. Application Data
(60) Provisional application No. 62/645,101, filed on Mar. 19, 2018.
(60) Provisional application No. 62/691,182, filed on Jun. 28, 2018.

(51) Int. Cl. G07C 9/00; G06K 7/10; F41A 17/06; G08B 21/02; H04L 9/06; H04L 9/32

(52) U.S. Cl. CPC G07C 9/00111; G06K 7/10366; F41A 17/063; G06Q 50/265; H04L 9/0637; H04L 9/3221; G08B 21/02

(57) ABSTRACT

A system for detecting the presence of firearms includes a radiofrequency identification (RFID) tag embedded within each firearm. The RFID tag may be passive or active but is preferably passive for permanent installation and long-term use. Using an Electronic Product Code (EPC) type data structure, the RFID tag stores a unique data string identifying the manufacturer, model, firearm type (object class), caliber and unique RFID tag number for the firearm. Public spaces, buildings, schools may install RFID readers to discretely transmit an interrogating signal from a distance without invasive searches. The reader systems may be integrated with building security for real-time tracking on a display, triggering automated alarms or triggering lockdown procedures. The unique RFID tag number obtained may be cross-referenced with other private data in secure, encrypted databases to maintain privacy.

### CROSS-REFERENCE TO RELATED APPLICATIONS

This application is a non-provisional filing of, and claims the benefit of, U.S. Provisional Application No. 62/645,101, filed Mar. 19, 2018, and U.S. Provisional Application No. 62/691,182, filed Jun. 28, 2018, the entire contents of which are both incorporated herein by reference.

### BACKGROUND OF THE DISCLOSURE

The present disclosure relates to firearm tracking and safety, and more particularly to a system for remotely detecting the presence of a firearm by employing radio frequency identification (RFID) tags permanently embedded within firearms and high-power, long-range RFID readers for detecting the RFID tags without invasive searches.

There are many situations in which it is desirable to have the ability to detect the presence of firearms and concealed carry permit holders from a distance and, in certain situations, to be able to determine certain information associated with the firearm, information associated with the permit holder, and information associated with the weapon's legal owner. For example, when police officers approach a vehicle for a traffic stop, it would be tremendously valuable for them to know whether a firearm is contained in the vehicle. Similarly, it is common practice to screen persons entering public places such as schools, airports, concert venues, stadiums and the like for firearms. In these situations, it would be very advantageous to be able to determine whether a firearm was carried by a person without physically searching the person, and to potentially determine whether there is an associated permit holder or owner in the same vicinity.

### SUMMARY OF THE INVENTION

Firearm-related violence is an ongoing concern in the US, yet neither government, nor private industry, has been able to find a solution that satisfies all parties. In this disclosure, a novel system and method for firearm detection, tracking and safety is proposed and which seeks to reduce firearm-related mortality while retaining citizens' right to own firearms and without overt intrusion into personal information and personal property.

As part of this novel system radio frequency ID (RFID) tags may be embedded in firearms by manufacturers and/or retrofitted by retailers or gun smiths and will allow each firearm to be detected from short to medium range distances around targeted areas, such as schools, public buildings and public spaces using high-power RFID readers. Additionally, RFID tags may also be imbedded in firearm permit holder ID cards. This capability will allow local detection and monitoring of firearms and permit holders in proximity of the system. However, specific identifying information related to the firearm and/or permit holder will be shielded to protect privacy.

Blockchain technology may be used to create a distributed ledger which will be outside the control of governments and corporations and will record firearms, associated owners, permit holders and an ownership history of each firearm. Encryption and zero knowledge (ZK) protocols will be used to ensure the privacy of the ledger and protect the identity of individual firearm owners. The remote detection of firearms and the secure, privacy-enhanced public ledger will bring forth a new paradigm of anonymous monitoring which seeks to make public spaces safer and reduce the frequency and severity of mass shooting incidents in the US yet maintain privacy for the vast majority of participants. The decentralized nature of blockchain and the enhanced privacy of zero knowledge protocols may make the present system more readily acceptable to the firearms community which is fiercely protective of privacy rights.

A novel system for detecting and tracking the presence of firearms may generally include a radiofrequency identification (RFID) tag supported or embedded within each firearm either by the manufacturer or by later retrofit. The RFID tag may be passive, or active, but is preferably passive for permanent installation and long-term use (lifetime of the firearm). Using an Electronic Product Code (EPC) type data structure, the RFID tag stores a unique data string identifying the manufacturer, type of firearm (object class-pistol/rifle/shotgun, etc), and a uniquely assigned tag number.

The system may further include an RFID tag imbedded within the physical ID cards as issued by the various states to authorized firearm owners and concealed carry permit holders. The RFID tag may be passive, or active, but is preferably passive for permanent installation and long-term use (lifetime of the identification card). Using an Electronic Product Code (EPC) type data structure, the RFID tag stores a unique data string identifying the issuing authority (state and/or local municipality), permit class type (FID, hunting, concealed carry, etc) and a uniquely assigned tag number.

Firearm serial numbers, owner names, and permit numbers are encrypted within the database and shielded from general access within a layered permission-based access protocol. Only generic information regarding the type of firearm and class of permit holder is directly available from a scan of the RFID tags. Only if, and when needed, can authorized users (manufacturers, retailers, law enforcement, courts) gain access to the associated information contained and shielded within the encrypted database.

Public spaces, parks, buildings, airports, train stations, concert venue, stadium, schools, etc. may install high power RFID readers to discretely transmit an interrogating signal from a distance without invasive searches. Newer, high power ultra-high frequency (UHF) reader systems can interrogate tags at distances up to 600 feet thereby allowing use in larger open spaces. A local computer/reader system may have a locally installed data set containing only manufacturer and object class information and/or permit class information so that the system can identify the type of weapon and/or permit type directly from the tag, but without deep access to the blockchain database. The reader systems may be integrated with building security for automated alarms and triggering of door locks, barriers, and other lockdown procedures. Such an independent local scanning system would allow granular detection and monitoring of weapons and permit holders in the immediate area but without immediately sacrificing privacy.

The local scanning system may also be connected to a wider communication network and the blockchain server and database, and a scanned tag number obtained by the scanner system may be used to access additional information about the firearm, owner or permit holder, as needed and where permitted.

An exemplary decentralized database and application for storing firearm, owner and permit holder data is disclosed. A decentralized blockchain database application (Dapp) based on a fork of the Ethereum™ Blockchain may be used to store firearm data, owner data, and permit data and will include a decentralized blockchain ledger for recording ownership history of each firearm. The privacy of firearm owners is of course a top priority, and especially the identity of law enforcement agents must be protected. To achieve this, multiple layers of encryption and zero knowledge (ZK) protocols will be used to maintain fine grained access control. Privacy enhancement techniques which are currently employed in certain blockchain implementations (for example ZCash™ and Monero™) will be used to ensure the anonymity of individual firearm owners in the many public facing scanning systems that may have access to the blockchain database and ledger. This feature will serve to address the privacy concerns which are important to firearm rights advocates.

The decentralized blockchain database and ledger will include a record for every firearm. The record is accessible by reading the RFID tag number. The database will also include encrypted user records for administrators, law enforcement officials, court officers, individual owners, and permit holders that can log into the system and be provided with granular access to certain data. Identities of individuals will be encrypted and the relationship between individuals, permits and associated firearms will be shielded from the general public and accessible only to users with the appropriate permission levels, i.e. law enforcement agencies, etc. A tiered security and permission level approach will allow for multiple levels of protection and access.

Whenever a firearm is manufactured, sold at retail or ownership of a firearm changed, a new record will be written into the blockchain ledger detailing the time, place and parties of the transaction. The blockchain will contain a complete history of ownership for each firearm, searchable by the firearm serial number, owner, permit holder, or RFID tag number. The right to update the ownership of a firearm will only be given to its owner, with the approval of a licensed dealer or retailer, who will physically identify the parties and facilitate the transaction. Ledger transactions will be implemented using smart contracts, similar to the way multisignature (multisig) wallets are implemented.

In another aspect of the invention, RFID tags embedded within firearms may be further provided with at least one additional sensing capability. For example, a passive UHF RFID tag and circuit may be provided with a force sensor to further detect and record whether the firearm has been fired. Because of the passive nature of the RFID tag, it is necessary that the tag be powered by the electromagnetic field of the reader. However, in a location with installed readers, the data generated could be used to identify a specific weapon that had been fired while within range of the reader.

Accordingly, it can be seen that the present disclosure provides a unique and novel system and method for detecting the presence of a firearm in public without invasive searches, tracking the presence of a firearm and permit holder, shielding personally identifying information, but also providing access if, and when, needed.

### BRIEF DESCRIPTION OF THE DRAWINGS

While the specification concludes with claims particularly pointing out and distinctly claiming particular embodiments of the present invention, various embodiments of the invention can be more readily understood and appreciated by one of ordinary skill in the art from the following descriptions of various embodiments of the invention when read in conjunction with the accompanying drawings in which:

FIG. 1 is a schematic diagram of an exemplary system for detecting and identifying a firearm in accordance with the teachings of the present disclosure;

FIG. 2 is a schematic view of an exemplary RFID tag, chip and antenna;

FIG. 3 is a table illustrating an exemplary data structure for a RFID firearm tag of the present system;

FIG. 4 is a table illustrating an exemplary data structure for a RFID permit tag of the present system

FIG. 5 is a schematic diagram of interaction between various accessing parties and the exemplary decentralized database and distributed ledger of the present system; and

FIG. 6 is a schematic diagram of an exemplary relational database including data records and a distributed ledger application in accordance with the teachings of the present invention.

### DETAILED DESCRIPTION OF THE EXEMPLARY EMBODIMENTS

Certain exemplary embodiments will now be described to provide an overall understanding of the principles of the structure, function, manufacture, and use of the device and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present disclosure. Further, in the present disclosure, like-numbered components of the embodiments generally have similar features, and thus within a particular embodiment each feature of each like-numbered component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Further, to the extent that directional terms like top, bottom, up, or down are used, they are not intended to limit the systems, devices, and methods disclosed herein. A person skilled in the art will recognize that these terms are merely relative to the system and device being discussed and are not universal.

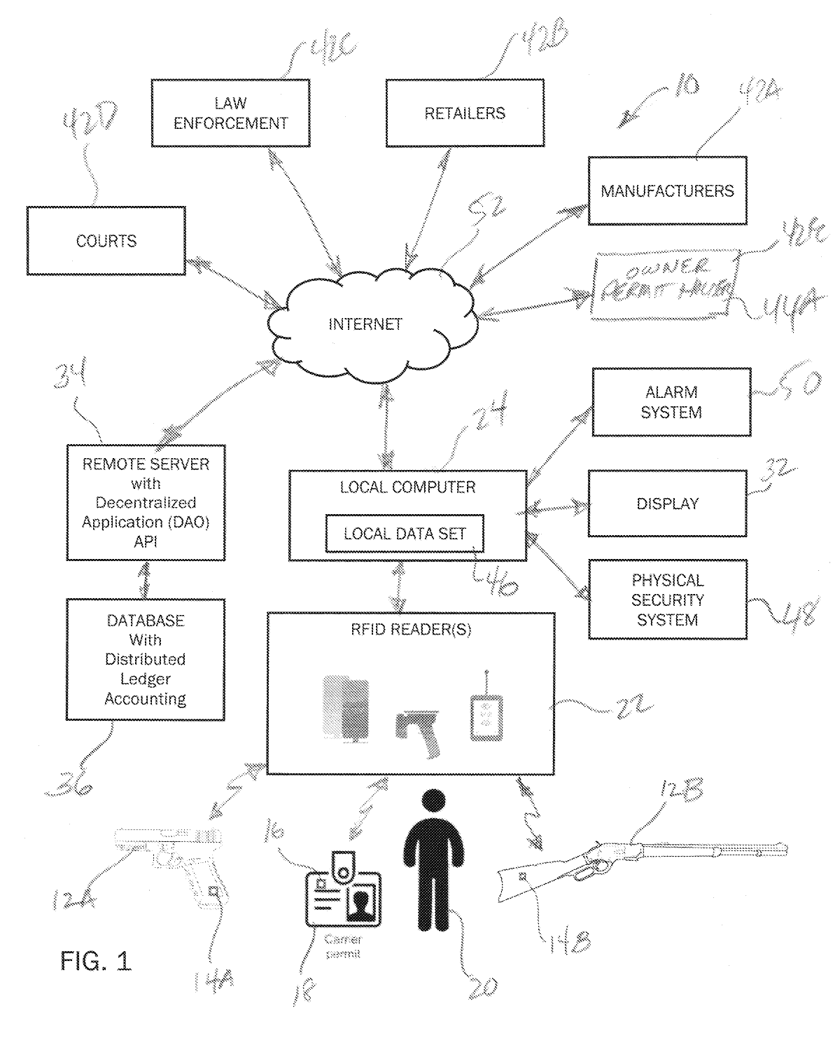

Referring now to the drawings, an exemplary embodiment of a system 10 employing the present invention is illustrated in FIG. 1. Generally, a system 10 for detecting the presence of firearms 12 includes a radiofrequency identification (RFID) tag 14 (firearm tag) permanently embedded within each firearm 12 either by the manufacturer or by later retrofit through a retailer or gun smith. Using an Electronic Product Code (EPC) type data structure, the RFID firearm tag 14 stores a unique data string identifying the manufacturer, model/type of firearm (object class—pistol/rifle/shotgun, caliber etc), and a uniquely assigned tag number (See FIG. 3).

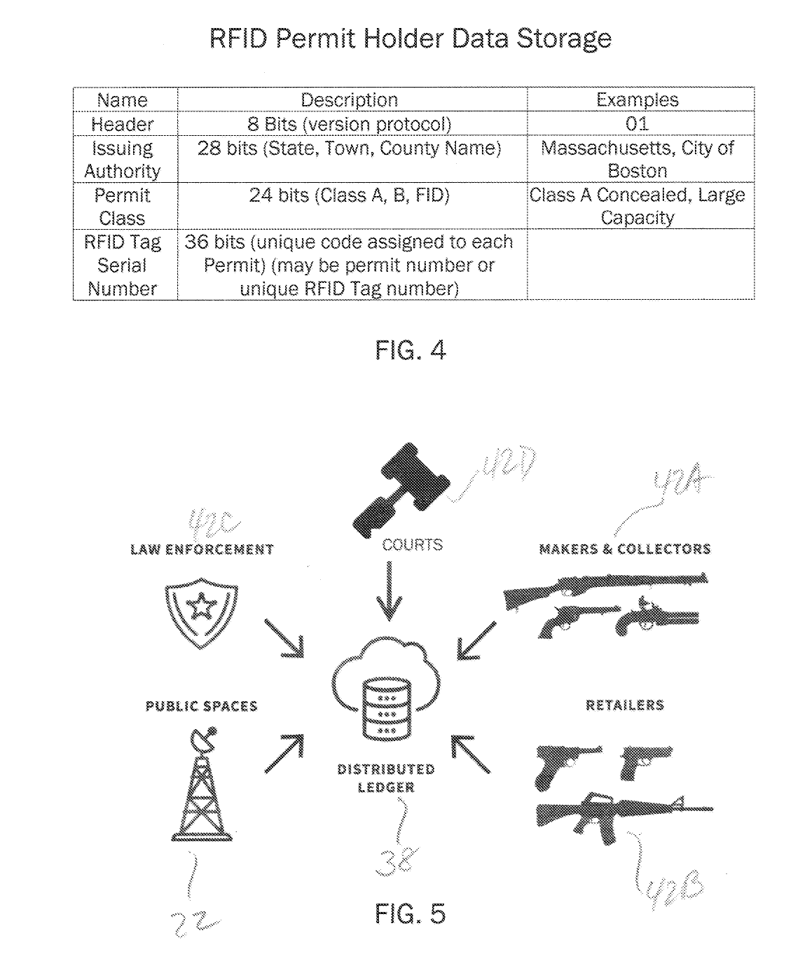

Additionally, the system 10 may include an RFID tag 16 (permit tag) embedded within a firearm permit holder identification card 18 (concealed carry permit, firearms identification card, etc.) as typically obtained by a firearm owner 20 prior to purchase of a firearm. Such permits are usually required to be carried by person when carrying or transporting firearms. Also using the familiar EPC type data structure, the RFID permit tag 16 stores a unique data string identifying the issuing authority (state and/or local municipality), permit class type (FID, hunting, concealed carry, etc) and a uniquely assigned tag number (See FIG. 4).

It is noted at the outset of this disclosure, that unique firearm serial numbers, owner names, and permit numbers are preferably encrypted and stored within a remote database and shielded within a layered, permission-based access protocol. Only generic information regarding the type of firearm and class of permit holders is intended to be directly available from a scan of the RFID tags 14, 16. Only if, and when needed, can authorized users of the system (manufacturers, retailers, law enforcement, courts) gain access to the associated information contained and shielded within the database. This will be described in further detail below.

An RFID reader 22 is connected to a local computer system 24 and is utilized to detect tags 10, 14 within a reasonably close proximity to the reader 22. This capability will allow local detection and monitoring of firearms 12 and permits 18 in proximity of the system 10. However, as noted above, specific personally identifying information related to the firearm 12 and/or permit 18 or permit holder/firearm owner 20 will be shielded to protect privacy.

Generally, a Radio-frequency identification (RFID) system uses RFID chips or tags attached to an object to be identified for tracking. Two-way radio transmitter-receivers called interrogators or readers generate electromagnetic fields and send signals to the tag and then read the tag's response. Unlike a barcode, the tag need not be within the line of sight of the reader, so it may be embedded in the tracked object. RFID is just one method for Automatic Identification and Data Capture (AIDC).

RFID tags can be either passive, active or battery-assisted passive. Active RFID tags have a local power source (such as a battery) and periodically transmit its ID signal. Because of the local power source, active RFID tags may operate hundreds of meters from the RFID reader. While active RFID tags are within the scope of this disclosure, these tags have some disadvantages when used in the context of firearm tracking. Because of the space requirements for locating a tag on a firearm, tags with batteries may be too large to be realistically contained within a firearm. Additionally, because it is preferred that the tag be permanently embedded within the firearm, replacement of the battery is not possible. RFID batteries have an effective life of 5-10 years at most, and thus would not be a permanent solution to provide tracking over extended periods of time.

A battery-assisted passive (BAP) has a small battery on board and is activated when in the presence of an RFID reader. While BAP may be a better option, the battery life and size still pos an issue for a permanent installation.

A passive RFID tag is a more preferred option because it is both smaller and because it does not have a battery. Passive RFID tags collect the electromagnetic energy from the nearby RFID reader's interrogating radio waves. The passive RFID tags include an antenna to collect energy from interrogating radio waves and convert that energy to temporarily power the circuit to transmit its stored information back to the reader.

Tags may either be read-only, having a factory-assigned tag number that is used as a key into a database, or may be read/write, where object-specific data can be written into the tag by the system user. Field programmable tags may be write-once, read-multiple. Entirely blank tags may be written with an electronic product code by the user.

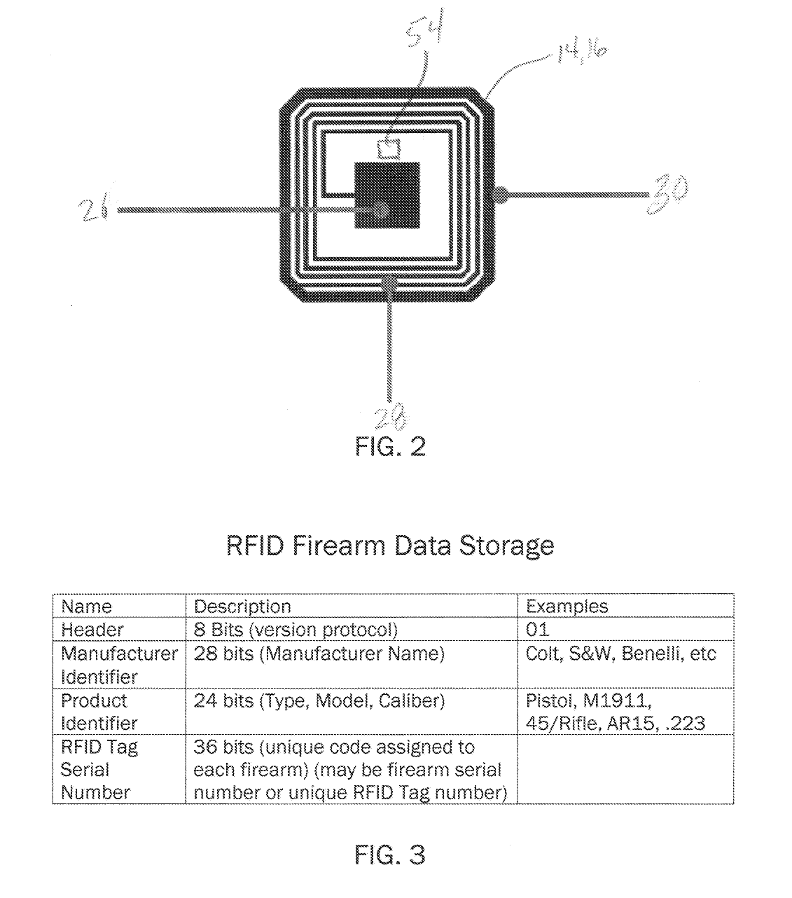

Referring now to FIG. 2, RFID tags 14, 16 contain at least three parts: an integrated circuit 24 for storing and processing information that modulates and demodulates a radio-frequency (RF) signals; an internal collector for collecting DC power from the incident reader signal 26; and an external antenna 28 for receiving and transmitting the signal. The larger the antenna 28, the longer distance at which the tag 14, 16 can be interrogated. Further, the closer an embedded tag 14, 16 is located to the surface of an object, the longer distance at which the tag can be interrogated.

The tag information or data is stored in a non-volatile memory. The RFID tag includes either fixed or programmable logic for processing the transmission and sensor data, respectively. In use, the RFID reader 22 transmits an encoded radio signal to interrogate the tag(s) 14, 16. The RFID tag(s) 14, 16 receives the message and then responds with its identification and other data. This may be only a unique tag number, or may be generic firearm related information such as manufacturer, model, type and caliber, or other relevant information. Since the tags 14, 16 have individual identification numbers, the RFID system design can discriminate among several different tags that might be within the range of the RFID reader 22 and read them simultaneously.

RFID systems can further be classified by the type of tag and reader. A Passive Reader Active Tag (PRAT) system has a passive reader which only receives radio signals from active tags (battery operated, transmit only). The reception range of a PRAT system reader can be adjusted from 1-2,000 feet (0-600 m), allowing flexibility in applications such as asset protection and supervision. An Active Reader Passive Tag (ARPT) system has an active reader, which transmits interrogator signals and also receives authentication replies from passive tags. An Active Reader Active Tag (ARAT) system uses active tags awoken with an interrogator signal from the active reader. A variation of this system could also use a Battery-Assisted Passive (BAP) tag which acts like a passive tag but has a small battery to power the tag's return reporting signal.

Fixed, mobile and handheld readers 22 may set up to create a specific interrogation zone which can be tightly controlled. This allows a highly defined reading area for when tags go in and out of the interrogation zone. Mobile readers may be hand-held or mounted on carts or vehicles.

Signaling between readers and tags is done in several different incompatible ways, depending on the frequency band used by the tag. Tags operating on LF and HF bands are, in terms of radio wavelength, very close to the reader antenna because they are only a small percentage of a wavelength away. In this near field region, the tag is closely coupled electrically with the transmitter in the reader. The tag can modulate the field produced by the reader by changing the electrical loading the tag represents. By switching between lower and higher relative loads, the tag produces a change that the reader can detect. At UHF and higher frequencies, the tag is more than one radio wavelength away from the reader, requiring a different approach. The tag can backscatter a signal. Active tags may contain functionally separated transmitters and receivers, and the tag need not respond on a frequency related to the reader's interrogation signal.

As briefly mentioned above, Electronic Product Code (EPC) is one common type of data stored in an RFID tag. When written into the tag by an RFID printer (not shown), the tag 14, 16 may contain a 96-bit string of data. Referring to FIGS. 3 and 4, the first eight bits are a header which identifies the version of the protocol. The next 28 bits may identify the organization that manages the data for this tag (firearm manufacturer/permit issuing authority); the organization number may assigned by the EPC Global consortium. The next 24 bits are an object class, identifying the kind of product (type/model/caliber) (permit class); the last 36 bits are a unique tag number. These last two fields are set by the organization that issued the tag. Rather like a URL, the total electronic product code number can be used as a key into a relational database to uniquely identify a particular item.

More than one tag 14, 16 can simultaneously respond to a tag reader 22, for example, many individual firearms 12 and permits 18 may be located in a common area. Two different types of protocols may used to “singulate” a particular tag 14, 16, allowing its data to be read in the midst of many similar tags. In a slotted Aloha system, the reader 22 broadcasts an initialization command and a parameter that the tags individually use to pseudo-randomly delay their responses. When using an “adaptive binary tree” protocol, the reader 22 sends an initialization symbol and then transmits one bit of ID data at a time; only tags with matching bits respond, and eventually only one tag matches the complete ID string. Both methods have drawbacks when used with many tags or with multiple overlapping readers.

It should also be understood that the concepts disclosed herein may be equally used with other “near-field” communication systems such as those employed by cellular phones. It is important to note however, that the passive tag systems disclosed herein are the best option for permanent installation on the firearm side. However, any system which was able to read the embedded RFID tag, or other type of permanently installed tag system would function equally as well.

Turning back to FIG. 1, a generic handgun 12A and a generic rifle 12B are illustrated and have RFID tags 14A and 14B permanently embedded into the frame or handgrip or stock. While the exemplary embodiment discloses a handgun and a rifle, it is intended that the scope of disclosure includes all types of firearms including rifles, handguns, shotguns, tasers, stunguns, etc.

As noted above, the RFID firearm tags 14A,14B are programmed to retain certain data related to the handgun or rifle 12 as assigned during its manufacture or later retrofit. The RFID tags 14A, 14B are preferably of the digital, passive type as described hereabove. Additionally, the permit tags 16 are programmed to retain certain data related to the permit 18 and permit holder 20 as assigned during its authorization and issue. The RFID permit tags 16 are preferably of the digital, passive type as described hereabove.

The reader 22 (or readers) for the RFID tags 14, 16 is capable of sending an interrogating signal to the tag(s) 14, 16 from a substantial distance, preferably up to at least 500-600 feet away, but this is not intended to be limiting. The reader 22 operates to send an interrogating signal out on an omnidirectional basis. If a tag 14, 16, compatible with the interrogating signal, is within range of the reader 22, the tag 14, 16 will receive the signal, store RF energy contained in the interrogating signal, and use that energy to transmit a responsive signal including an object code (firearm) and the tag number stored in the tag 14, 16. If no compatible RFID tag is within the range, no responsive signal will be received. In the event a number of devices embedded with RFID tags are within the range, a plurality of signals will be received and the technologies as described hereabove will be used to separate the signals. This program is embedded in the local computer 24 connected to the reader 14. The computer 24 may include a display 32 for displaying the information retrieved from the responding tag(s) 14, 16.

The system 10 further includes a remote server 34 running a decentralized application API and is further connected to an encrypted database 36 for storing firearm, owner and permit holder data. A decentralized blockchain database application (Dapp) based on a fork of the Ethereum™ Blockchain may be used to interface with the server 34 and access firearm data, owner data, permit data when authorized. The database 36 may include a decentralized blockchain ledger 38 for recording ownership history of each firearm 12. The privacy of firearm owners is of course a top priority, and especially the identity of law enforcement agents must be protected. To achieve this, multiple layers of encryption and zero knowledge (ZK) protocols will be used to maintain fine grained access control. Privacy enhancement techniques which are currently employed in certain blockchain implementations (for example ZCash™ and Monero™) will be used to ensure the anonymity of individual firearm owners in the public facing scanning systems 22,24 that have access to the database 36.

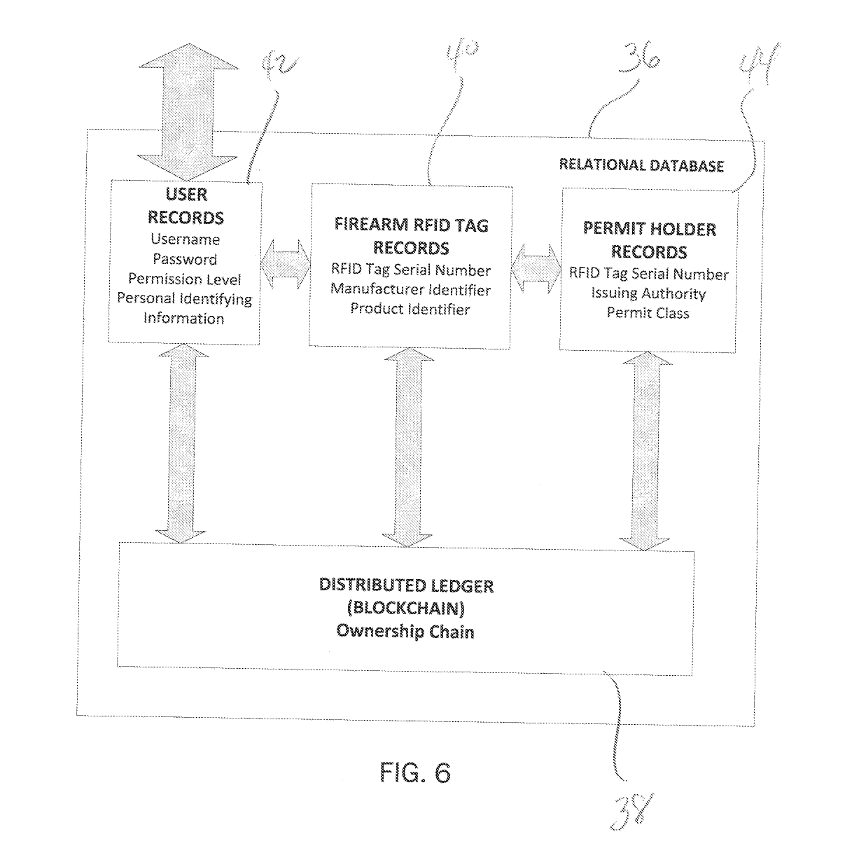

Referring to FIG. 6, the decentralized blockchain database 36 and ledger 38 will include a record 40 for every firearm 12. The 40 record is accessible by reading the RFID tag number. The database 36 will also include encrypted user records 42 for various types of users, i.e. administrators, manufacturers 42A, retailers 42B, law enforcement officials 42C, court officers 42D, individual owners 42E, and also records 44 for permit holders 44A that can all log into the system 10 and be provided with granular access to certain data. FIG. 5 illustrates the various relationships of users with the database 36 and distributed ledger 38. As previously mentioned, the identities of individuals will be encrypted and the relationship between individuals 20, permits 18 and associated firearms 12 will be shielded from the general public and accessible only to users with the appropriate permission levels, i.e. user, law enforcement agencies, etc. A tiered security and permission level approach will allow for multiple levels of protection and granular access.

It is contemplated that public spaces, parks, buildings, airports, train stations, concert venue, stadium, schools, etc. may install high power RFID readers 22 to discretely transmit an interrogating signal from a distance without invasive searches. As described above, newer, high power ultra-high frequency (UHF) reader systems can interrogate tags at distances up to 600 feet thereby allowing use in larger open spaces.

The local computer/reader system 22,24 may, in an exemplary system, have a locally installed data set 46 containing only manufacturer and object class information and/or permit class information so that the system can identify the type of weapon and/or permit type directly from the tag 14, 16, but does not have access to the decentralized blockchain database 36.

In other exemplary systems, local reader/computer 22, 24 may be integrated with building security systems 48 for triggering of physical door locks, barriers, and to automated alarms 59 for other lockdown procedures. There are multiple levels of use of the system once implemented. For example, in a public park, the system may simply be used to track firearms within the park. Lawful firearm owners, police and armed security may be tracked and anonymously identified within the park (i.e. lawful weapon/lawful permit), and this information may be useful to park security on a general, but entirely local, basis. There may be no need to act on the information unless an incident occurs. In this regard, a very low level of information may be retrieved and displayed to the operator, i.e. object class, and whether the weapon is associated to a lawful owner (ZK proof), i.e. there is a lawful firearm registered to a lawful permit holder in the vicinity (without revealing any more specific information). ZK proof may thus provide information to officials with the least invasion of privacy.

In another exemplary implementation, such as a school, where the presence of a weapon is not the norm, the detection of a firearm 12 may immediately trigger physical security measures, such as locking doors and sounding alarms. If an armed security officer is located on the campus, the local system may be programmed to include a list of allowed firearms 12 (i.e. firearm tags 14) for known personnel.

The local scanning system may also be connected to a wider communication network (internet) 52 and the blockchain server 34 and database 36, and a scanned tag number obtained by the scanner system 22, 24 may be used to access additional information about the firearm 12, owner 20, or permit holder 18, as needed, and where permitted. In the event that an incident occurs, a scanned tag number obtained by the system may be used with remote database 36 to obtain additional information about the firearm 12 and/or owner 20 and/or permit holder 18.

The systems of the present invention could also be used with closer proximity walk-through systems of the type used at airports and the like which may also incorporate RFID readers 22. These reader systems could be integrated with traditional walk-through security gates, or may simply be installed within door frames or structural building arches so that they are unobtrusive.

The system might also comprise a mobile handheld reader system to be used with crowd control officers, general security, mobile police traffic stops, and in vehicles etc. Wherever law enforcement would benefit from knowing that a firearm 12 may be present in the immediate area, a system can be implemented.

In another aspect of the invention, RFID tags 10 embedded within firearms may be further provided with at least one additional sensing capability. For example, a passive UHF RFID tag and circuit may be provided with a force sensor 54 (See FIG. 2) to further detect and record whether the firearm 12 has been fired. An exemplary type force sensor is a resistive sensor, such as a FlexiForce A201 force sensor manufactured by Tekscan, Inc. of South Boston, Mass. Because of the passive nature of the RFID tag, it is necessary that the tag and resistive circuit be powered by the electromagnetic field of the reader. However, in a location with installed long-range tag readers, the tag 14, 16 may be powered during its presence within the reading field, and if fired on location, the data generated could be used to identify a specific firearm hat had been fired while within range of the reader 22.

Turning back to the general database structure (FIG. 6), whenever a firearm 12 is manufactured, sold at retail or ownership of a firearm changed, a new record will be written into the blockchain ledger 38 detailing the time, place and parties of the transaction. The blockchain ledger 38 will contain a complete history of ownership for each firearm 12, searchable by the firearm serial number, owner 20, permit holder 18, or RFID tag 14, 16. The right to update the ownership of a firearm 12 will only be given to its owner, with the approval of a licensed dealer or retailer, who will physically identify the parties and facilitate the transaction. Ledger transactions may be implemented using smart contracts, similar to the way multisignature (multisig) wallets are implemented.

More specifically, in the context of retail sale, the firearm retailer 42B, upon selling a firearm 12 may use a stationary tag reader 22 at the point of sale or may use a portable hand-held RFID tag reader or other transmitting device reader to scan the RFID tag(s) 14, 16 of the firearm 12 and permit holder 18, and then enter the new owner's information and credentials. When a firearm owner 20 wants to sell his/her firearm 12, he/she would need to go to a firearm retailer 42B to complete the transaction. The firearm retailer 42B would scan the RFID tag 14 for the tag number of the firearm 12 to confirm the legal owner is the seller and then enter the new owner's information and credentials. [60] As noted above, RFID readers 22 may be installed in public spaces such as malls, airports, train stations, and schools, and may detect firearms without the need for invasive body searches. The entire scanning system may be connected to the internet 52 and to a decentralized blockchain system 34, 36 which may search the records and firearm ledger for every firearm detected. This integrated system allows for anonymous identification and tracking. However, when a firearm 12 is stolen or misplaced, its owner may update the database records and ledger and flag his firearm 12. When the firearm 12 is detected by sensors 22 in any location (for example in the EZPass™ highway monitoring system), the system 10 may notify law enforcement immediately. Such a system potentially lowers the risk and insurance costs of firearm ownership, as stolen or illegally transferred weapons will be more easily found and retrieved than they are today.

Furthermore, the system can be programmed for permissive access for certain firearms so that law enforcement agents with concealed weapons could walk in and out of public spaces without having to reveal their identity or firearms. This allows for easier law enforcement movement and faster response times for first responders.

In the case of a shooting incident, systems with multiple readers 22 at various locations in a target area may be able to perform triangulation on the perpetrators' firearm and give law enforcement personnel a valuable tactical advantage in crisis situations.

Having thus described certain particular embodiments of the invention, it is understood that the invention defined by the appended claims is not to be limited by particular details set forth in the above description, as many apparent variations thereof are contemplated. Rather, the invention is limited only be the appended claims, which include within their scope all equivalent devices or methods which operate according to the principles of the invention as described.

What is claimed is:

1. A system for detecting firearms comprising:
a firearm;
a passive, ultra-high frequency (UHF) radio-frequency identification RFID tag permanently embedded within said firearm, said RFID tag having firearm data encoded therein, said firearm data including at least an object class and a unique RFID tag identification number;
a UHF RFID reader for generating an electromagnetic reading field effective for interrogating said RFID tag, said reader being operative for receiving said firearm data from said interrogated RFID tag; and
a local computer operative with the RFID reader to receive said firearm data and to generate an output signal.

2. The system of claim 1, further comprising an alarm system associated with said computer system, said alarm system being responsive to said output signal.

3. The system of claim 1, further comprising a security locking system associated with said computer system, said security locking system being responsive to said output signal.

4. The system of claim 1 further comprising a display system associated with said computer system, said display system being responsive to said output signal.

5. The system of claim 1 wherein said local computer includes a database comprising at least said object class data such that said local computer system can identify a firearm type.

6. The system of claim 1 further comprising a communications network and a remote computer system including a server running a decentralized application API, and an encrypted database with a decentralized distributed ledger.

7. The system of claim 6, wherein said firearm has a firearm serial number, said firearm serial number being stored within said encrypted database and associated with said unique RFID tag number.

8. The system of claim 7 wherein said encrypted database further includes owner data which is associated with said firearm serial number and/or said unique RFID tag number.

9. The system of claim 1 wherein the RFID tag further includes a force sensor.

10. A system for monitoring firearms and firearm permit holders comprising:
a firearm;
a passive, ultra-high frequency (UHF) radio-frequency identification RFID firearm tag permanently embedded within said firearm, said RFID firearm tag having firearm data encoded therein, said firearm data including at least an object class and a unique RFID firearm tag identification number;
a firearm permit holder identification card;
a passive, ultra-high frequency (UHF) radio-frequency identification RFID permit tag permanently embedded within said identification card, said RFID permit tag having permit data encoded therein, said permit data including at least a permit class and a unique RFID permit tag identification number;
a UHF RFID reader for generating an electromagnetic reading field effective for interrogating said RFID firearm tag and/or said RFID permit tag, said reader being operative for receiving said firearm data and/or said permit data from said interrogated RFID firearm tag and/or said interrogated RFID permit tag; and
a local computer operative with the RFID reader to receive said firearm data and/or said permit data and to generate an output signal.

11. The system of claim 10, further comprising an alarm system associated with said computer system, said alarm system being responsive to said output signal.

12. The system of claim 10, further comprising a security locking system associated with said computer system, said security locking system being responsive to said output signal.

13. The system of claim 10 further comprising a display system associated with said computer system, said display system being responsive to said output signal.

14. The system of claim 10 wherein said local computer includes a database comprising at least said object class data and at least said permit class data such that said local computer system can identify a firearm type and permit type.

15. The system of claim 10 further comprising a communications network and a remote computer system including a server running a decentralized application API, and an encrypted database with a decentralized distributed ledger.

16. The system of claim 15, wherein said firearm has a firearm serial number, said firearm serial number being stored within said encrypted database and associated with said unique RFID firearm tag number.

17. The system of claim 16 wherein said encrypted database further includes owner data which is associated with said firearm serial number and/or said unique RFID tag number.

18. The system of claim 15 wherein said permit holder identification has a permit number, said permit number being stored within encrypted database and associated with said unique RFID permit tag number.

19. The system of claim 16 wherein said permit holder identification has a permit number, said permit number being stored within encrypted database and associated with said unique RFID permit tag number.

20. The system of claim 17 wherein said permit holder identification has a permit number, said permit number being stored within encrypted database and associated with said unique RFID permit tag number.
